(19) United States
(12) Patent Application Publication
(10) Pub. No.: US 2001/0018015 A1
(43) Pub. Date: Aug. 30, 2001

(54) PERSONNEL TRANSFER CAPSULE

(76) Inventor: KERNEY H. JOHNSON, LAKE JACKSON, TX (US)

Correspondence Address: BRACEWELL & PATTERSON, SOUTH TOWER PENNZOIL PLACE, 711 LOUISIANA STREET, SUITE 2900, HOUSTON, TX, 770022781

(21) Appl. No.: 09/303,382

(22) Filed: Apr. 30, 1999

(51) Int. Cl. B60P 1/64; B63B 25/00

(52) U.S. Cl. 414/139.5

(57) ABSTRACT

A transfer system for transferring personnel, personal gear and/or delicate freight which includes walls and a base defining a shape having a large bottom area which is generally tapered toward the top for defining an inner space capable of carrying objects and personnel therein. A load bearing support structure supports the base and walled surfaces over a large surface area and is capable of being attached to a lifting device such as a crane hook. A central support member for personnel is attached to the base of the structure and includes a dynamic compression system for supporting and distributing various weights.

The load bearing central support structure is designed to create multiple pressure and stress points for decreasing the force exerted at each point. This may be accomplished through the use of multiple load bearing members. Typically, the load bearing members are straps disposed in the shell.

### FIELD OF THE INVENTION

This invention relates to an apparatus designed to transfer personnel and/or personal equipment from one vessel to an offshore installation or another vessel. In a preferred embodiment, it relates to an apparatus for safely transferring personnel and personal equipment from a vessel to an offshore installation or another vessel, where the transfer requires the apparatus to be transported vertically from one site to the other.

### BACKGROUND OF THE INVENTION

The process of transferring personnel and equipment from one vessel to an offshore installation or other vessel while both are at sea has typically been one of the most difficult and dangerous aspects of offshore platform work. This process is exacerbated where rough seas or high wind conditions are present.

Most offshore transfers involve the use of a crane to hoist and move the apparatus that carries personnel and equipment from an offshore platform to a support vessel, or vice versa. Currently, the preferred apparatus to accomplish such a transfer is a rope basket having a rigid bottom, commonly known in the industry as a “Billy Pugh” basket. Personnel stand on the rigid bottom and hold onto the rope lines for support and safety. This apparatus has several major drawbacks. First, personnel are not typically secured to the basket. Second, personnel are not protected in any way from impact during the transfer. Third, additional space to transfer equipment is minimal. Finally, there is no provision to protect personnel and equipment in the event of submersion of the basket.

Another common method of transfer in the past was the use of a ladder. The ladder was hung from the larger vessel or platform and personnel were required to navigate their way from the smaller vessel up the ladder or vice versa. This process involved moving across a gap between the smaller vessel and the ladder. The disadvantages of this method are obvious. First, the only equipment that can be transferred with this method is that carried by the personnel. Second, this method is particularly hazardous during high seas or rough weather conditions, as the personnel must, at some point, span the gap which can vary greatly depending on the relative movement of the two vessels. Third, this method required a relatively high degree of skill and agility to accomplish safely.

Another structure for transferring personnel and equipment is shown in U.S. Pat. No. 5,713,710 to Strong et al. The Strong patent discloses an apparatus for transferring objects from a first location to a second location. This transfer is accomplished through the use of a lifting device and a transfer device. The transfer device comprises an outer structure which defines an inner space in which an object to be transferred may be located and a securing device to secure the object to the transfer device during transfer. In addition, Strong discloses the use of a central load bearing member which is adapted to be coupled to the lifting device. The load bearing member is attached to the base of the outer structure and supports the entire weight of the transfer device and its contents during transfer. The transfer device of Strong is buoyant and self-righting when in water. The transfer device disclosed in Strong may include shock absorbing means on the underside.

### SUMMARY OF THE INVENTION

The current invention is an improvement over the Strong device and relates to an apparatus for transferring personnel, personal equipment and/or delicate freight from one vessel or installation to another in a safe, convenient manner. The transfer system comprises walls and a base defining a shape having a large bottom area which is generally tapered toward the top for defining an inner space capable of carrying objects and personnel therein. In the preferred embodiment of the invention the load bearing support structure supports the base and walled surface over a large surface area and is capable of being attached to a lifting device such as a crane hook. A central support member for personnel is attached to a point on the base of the apparatus and a point on the top portion of the apparatus to provide stable support for a seating assembly and includes a dynamic compression system for supporting and distributing various weights.

The load bearing central support structure of the present invention is designed to create multiple pressure and stress points, thereby decreasing the force exerted at each point. This may be accomplished through the use of multiple load bearing members. Preferably, the load bearing members are straps disposed in the shell of the apparatus.

Typically, the apparatus of the present invention is used to transfer personnel and/or personal equipment between a vessel or platform and a support vessel. In most circumstances, this transfer will involve the use of a crane to lift the apparatus from the deck of one vessel and deliver safely to the deck of the other vessel or platform. In such cases, the apparatus will have a device whereby a line from the crane can be attached to the apparatus. Usually this attachment device will be located at the top portion of the apparatus. Preferably the apparatus will have a line tensioner disposed between the attachment device and the lifting means to compensate for vessel heave or loss of station of the smaller vessel, especially in rough seas. In addition, the apparatus may have disposed on its top portion an emergency loop cable capable of supporting the entire weight of the apparatus and its contents should they become detached from the lifting means, such that personnel inside the apparatus could attach the loop cable to a lifting means and thereafter be transported.

When used for transferring personnel, the apparatus will have at least one seat attached to the central support member and resting on a dynamic compression system. The central support member is attached to the base of the apparatus and supports only the weight of the personnel in the seats or any equipment placed on the seats. The dynamic compression system can be, for instance, a spring having a variable spring rate and capable of supporting at least one person. In one embodiment, any number of the seats may be removed to accommodate, for example, a stretcher for transporting injured personnel or additional equipment as required. In an alternative embodiment, a stretcher may be carried inside the apparatus without removing any seats or may be attached directly to a seat or directly to a seat support member after removal of one or more seats. In addition, there will be space available to store and transfer equipment even when the apparatus is accommodating three personnel, such that the equipment is not disposed under the seats. By not storing equipment under the seats two improvements are achieved, first, the apparatus is safer because the movement of the dynamic support system will not be impeded by an overabundance of equipment stored beneath the seats and second, the seating level can be lowered, thereby lowering the center of gravity of the device thus making it more stable, especially when deposited in water. The seats of the apparatus are preferably high backed, orthopedic seats capable of providing both back and neck support to personnel in the event of a sudden shock. A device for securing personnel inside the apparatus will also be included. Such a device may include, for instance, a harness system or seat belts. Preferably, operation of the device does not require input or effort from the occupants of the apparatus. Therefore, it is ideal for transferring injured personnel either in a seated position or by stretcher.

In a preferred embodiment, the transfer apparatus of the invention includes shock absorbing devices attached to the exterior surface of the shell. These devices will absorb the energy of impact should the apparatus come into contact with another object during transfer, which can happen during rough seas or high winds. The apparatus will also have shock absorbing devices attached to the lower surface of the base to dampen impact when the apparatus is placed onto the deck of a vessel or other surface, again being particularly important during high seas.

The shell and load bearing support members of the apparatus will be fire retardant. In addition, a fire retardant shade or covering may be attached to the apparatus to effectively shield the personnel inside from heat or flash fire.

The apparatus has a positive buoyancy such that it will remain afloat should it be deposited in water. In addition, the apparatus will have a self-righting feature to bring it into an upright position in the water. Such self-righting feature may be achieved, for instance, through the use of a keel attached or integrated in the base of the apparatus. The apparatus is designed so that the water line will be substantially below the level of the personnel secured inside.

In order to make construction more efficient, a preferred embodiment of the apparatus of the present invention is capable of being formed from two halves, an upper half and a lower half. The two halves are joined and the joint is covered on the exterior surface by the shock absorbing devices. In a preferred embodiment, the each half is flanged along the joining edge such that the two halves can be secured together using bolts, for instance.

As an additional safety feature of the present invention, the apparatus may include a lighting system for use during night operation or during emergencies. Such lighting system may include interior lights capable of generally lighting the interior area of the capsule and may also include strobe-type lights such as those typically used in emergency situations. The apparatus may also have a device for emitting sound to help locate the apparatus in low visibility conditions.

It is, therefore, an object and feature of the subject invention to provide an apparatus for safely transferring personnel and/or equipment between two vessels or a vessel and an offshore installation, the apparatus having a load bearing support structure.

It is a further object and feature of the subject invention to provide an apparatus having positive buoyancy and a self-righting capability.

It is also an object and feature of the subject invention to provide an apparatus having a shock absorbing device disposed on the exterior surface of it's outer shell in order to absorb impact with another object during a transfer.

It is yet another object and feature of the subject invention to provide an apparatus capable of being formed from two halves.

Other objects and features of the invention will be readily apparent from the accompanying drawings and detailed description of the preferred embodiments.

### BRIEF DESCRIPTION OF THE DRAWINGS

FIG. 1 is a side elevation of the transfer apparatus.

FIG. 2 is a bottom view of the transfer apparatus.

### DETAILED DESCRIPTION OF THE PREFERRED EMBODIMENTS

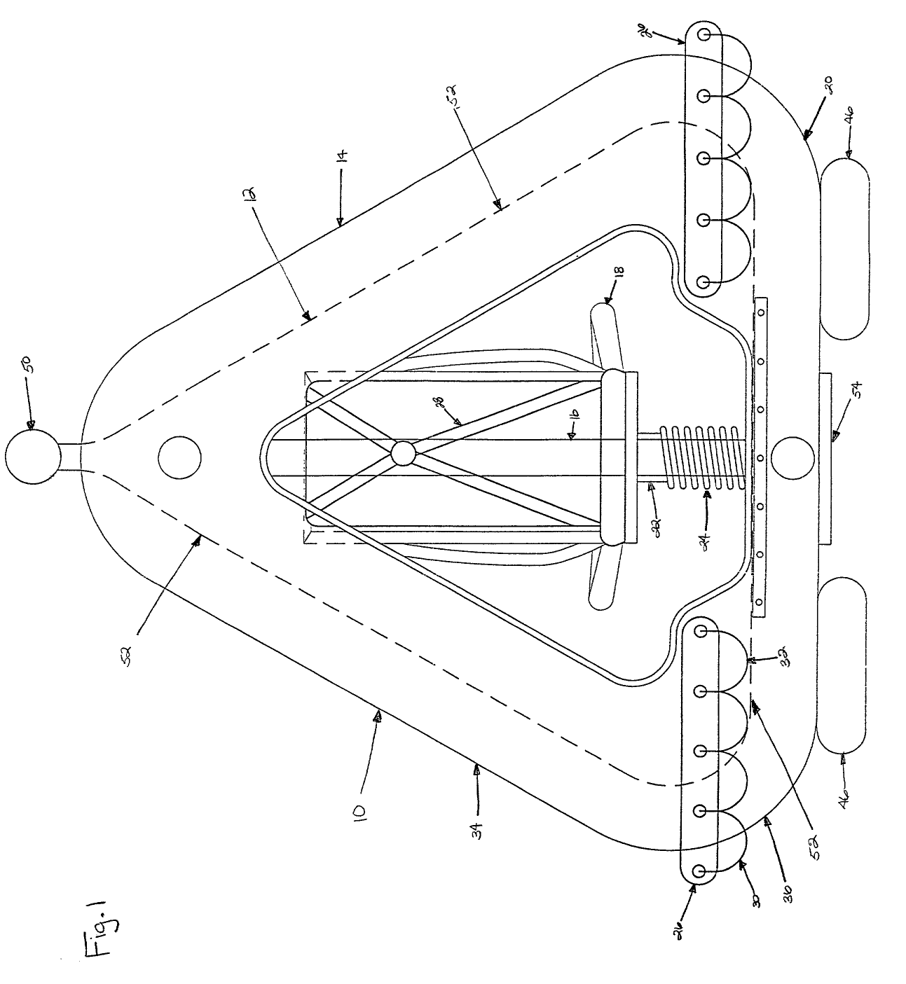

An embodiment of the present invention is shown in FIG. 1. The apparatus is a hard shelled capsule 10 useful for transferring both personnel and cargo from a support vessel to an offshore platform or other vessel. The capsule has an internal, load bearing support structure 12 capable of spreading the load from the weight of the capsule and it's contents over a relatively broad area. This increases both the stability and durability of the capsule, as it creates multiple pressure and stress points by distributing the various forces over a large area of the structure. One disadvantage of the prior art capsules (i.e. U.S. Pat. No. 5,713,710) was the use of a central load bearing member. The central load bearing member supports the entire weight of the capsule and its contents and focuses this load in a relatively small area at the capsule's base. The present invention seeks to avoid this disadvantage by providing a support system integrated into the shell of the capsule. By significantly spreading the loading forces over a much broader area, the present invention allows for the use of lighter materials. This can decrease material costs while maintaining or increasing the level of safety to personnel and equipment. The various components 52 of the load bearing support structure culminate near the top of the apparatus and are there attached to a connecting means 50 capable of being joined to a crane hook, for instance. In a preferred embodiment, a line tensioner is inserted between the connecting means and the lifting means. The tensioner is capable compensating for the movement of the smaller vessel, especially during rough seas.

The shell 14 of the capsule must be resistant to impact and capable of absorbing the shock of an impact without substantially losing it's shape or structural integrity. It can be formed from any of a number of suitable materials, for instance, plastic, fiberglass, or resin. A preferred material for construction of the shell is phenolic fiberglass resin. Typically, the shell material and load bearing straps are also fire retardant. The fire retardant feature can be achieved through the use of an additive combined with the shell material during processing or it can be achieved through the application of a fire retardant to the surface of shell, for instance, by spraying or painting.

The capsule 10 is both buoyant and self-righting in the event that it is deposited in water. In a preferred embodiment, the capsule of the present invention has sufficient buoyancy to maintain the personnel in the capsule above the water line. In addition, the capsule has sufficient ballast 54 in the base to render it self-righting should the capsule be deposited in water in an other than upright position.

The apparatus features a central support member 16 capable of supporting personnel and/or equipment during transfer. Typically, this member will support seats 18 capable of carrying personnel. The central support member 16 is attached to the base 20 of the shell 14. In one embodiment, the base 20 of the capsule 10 is strengthened with additional reinforcement to further support the weight of the central support member, personnel and equipment. Disposed on the support member 16, below the seating attachment 22 is a dynamic compression spring 24. The spring has a variable rate and is thereby capable of supporting a varying load, such as at least one person and/or a varying amount of equipment. The spring serves to dampen the shock forces to personnel and equipment during transport. The spring also serves to maintain the seats 18 at a relatively constant level regardless of the amount of load placed upon it.

The seats 18 of the apparatus can be made from any of a number of suitable materials, for instance, plastic, fiberglass or resin. They should have high backs capable of providing head and neck restraint. In a preferred embodiment, at least one of the seats may be removable to allow for the transport of a stretcher or other equipment needing horizontal support.

In order to safely secure equipment and personnel inside the apparatus, the seats will have a harness system 28 which can include, for instance, seat belts or other multipoint restraint system.

The seats 18 are attached to the central support member 16 by a metal collar. The collar is capable of sliding up and down the length of the support member but has a diameter small enough to limit excess lateral movement. Attached to the collar are at least one seat support member for attaching the seats. Preferably, the seat support members are metal. More preferably, the seat support members are steel box sections.

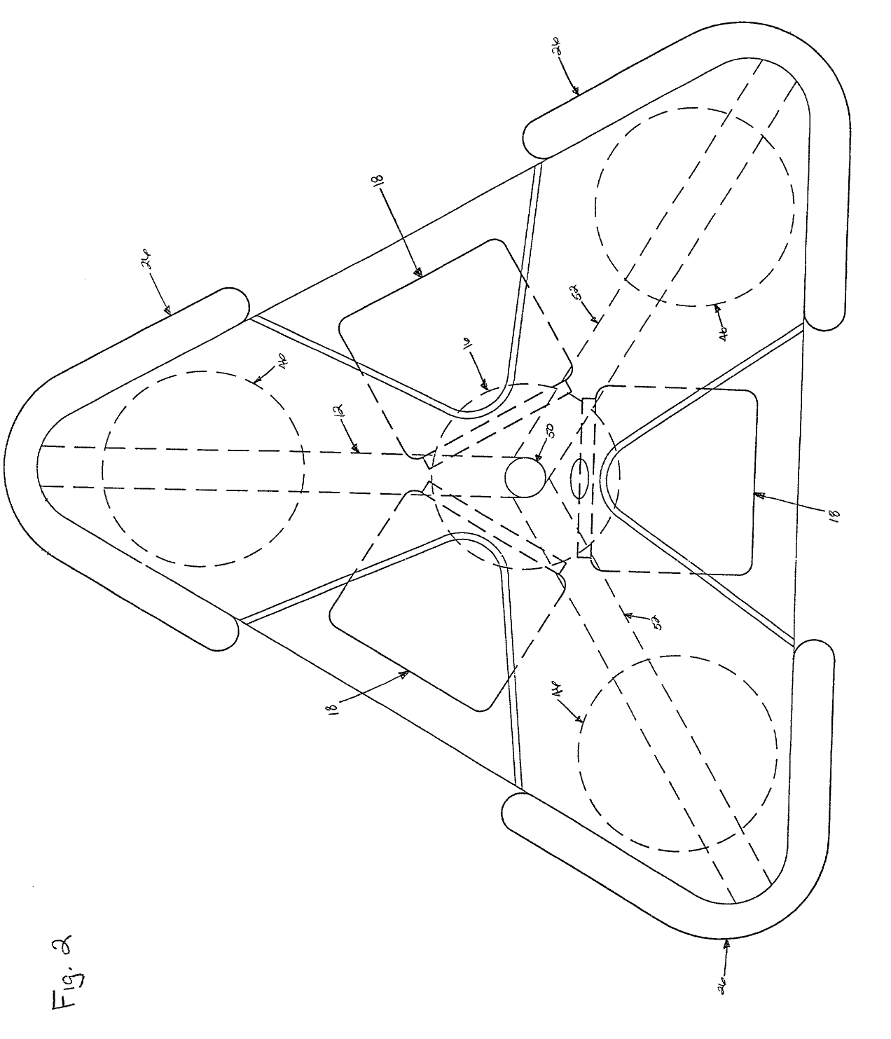

The shell 14 of the apparatus has disposed on its outer surface a plurality of shock absorbing devices 26. As shown in FIGS. 1 and 2, these devices 26 are preferably attached to substantially cover each corner of the apparatus. The shock absorbing devices can be produced from any of a number of suitable materials, including, but not limited to, elastomers and plastics. Additionally, the shock absorbing devices 26 may have relatively short lengths of rope or wire 30 attached such that the lengths form loops 32 across the surface of the device. These loops can be used, for instance, to attach lines useful in guiding the apparatus during transport.

In a preferred embodiment, the outer shell 14 of the apparatus is formed by joining two halves, an upper half 34 and a lower half 36. The upper half forms the walls 38 of the apparatus while the lower half forms the base 20. The two halves placed together to form a joint. Preferably, the two halves are sealed such that the resulting joint is water tight. The shock absorbing devices 26 are typically placed such that they substantially cover the joint formed by the two halves.

The capsule 10 of the current invention has shock absorbing means 46 disposed on the bottom, outer surface 48 of the base 40 to lessen the shock transmitted to equipment and personnel when the capsule is lowered onto a deck or other site. These shock absorbing means can be any of a number of materials or devices commonly known in the art.

While certain embodiments and features of the current invention have been described in detail herein, it will be understood that the invention encompasses all enhancements and modifications within the scope and spirit of the claims that follow.

What is claimed is:

1. An apparatus for transferring objects comprising:
a. a plurality of walls and a base defining an inner space capable of carrying objects therein, said walls having an interior surface and an exterior surface and said base having an upper and lower surface;
b. a load bearing support structure in contact with said walls and capable of being attached to a lifting device;
c. a central support member attached to the base, said central support member having disposed thereon a dynamic compression system.

2. The apparatus of claim 1, further comprising at least one shock absorbing device is attached to the exterior surface of said walls.

3. The apparatus of claim 2, further comprising a plurality of shock absorbing devices are attached to the lower surface of said base.

4. The apparatus of claim 1, further comprising at least one seat attached to said central support member.

5. An apparatus for transferring objects comprising:
a. an outer shell defining an interior space comprised of an upper half and a lower half, said upper half having an interior and exterior surface and said lower half having an upper and lower surface;
b. a load bearing support structure disposed on the interior surface of said upper half of said outer shell;
c. a plurality of shock absorbing devices attached to the exterior surface of the upper half of said outer shell, at the junction between the upper and lower halves;
d. a plurality of shock absorbing devices attached to the lower surface of the lower half of said outer shell.
